(19) United States
(12) Patent Application Publication
(10) Pub. No.: US 2023/0307991 A1
(43) Pub. Date: Sep. 28, 2023

(54) ELECTRIC MACHINE ARRANGEMENT

(71) Applicant: Schaeffler Technologies AG & Co. KG, Herzogenaurach (DE)

(72) Inventors: Dirk REIMNITZ, Bühl (DE); Ivo AGNER, Bühl (DE)

(73) Assignee: Schaeffler Technologies AG & Co. KG, Herzogenaurach (DE)

(21) Appl. No.: 18/022,810

(22) PCT Filed: Jul. 21, 2021
(86) PCT No.: PCT/DE2021/100632

§ 371 Date: Feb. 23, 2023

(30) Foreign Application Priority Data
Aug. 26, 2020 (DE) 10 2020 122 249.1

(51) Int. Cl. H02K 7/12; H02K 21/24

(52) U.S. Cl. CPC H02K 7/12; H02K 21/24

(57) ABSTRACT

An electric machine arrangement including an electric machine for driving an electrically drivable motor vehicle, having a stator and having a rotor, and also including an output element that is in rotationally fixed contact with the rotor. An axially elastic length-compensation element for transmitting a torque is arranged between the electric machine and the output element.

### CROSS-REFERENCE TO RELATED APPLICATIONS

This application is the U.S. National Phase of PCT Appln. No. PCT/DE2021/100632, filed Jul. 21, 2021, which claims the benefit of German Patent Appln. No. 102020122249.1, filed Aug. 26, 2020, the entire disclosures of which are incorporated by reference herein.

### TECHNICAL FIELD

The present disclosure relates to an electric machine arrangement comprising an electric machine for driving an electrically drivable motor vehicle, having a stator and having a rotor, and an output element that is in rotationally fixed contact with the rotor.

### BACKGROUND

For electric motors, it is important to align the parts through which the magnetic field flows very precisely, since even small deviations in the position of the parts among one another can have a significant effect on the magnetic flux (e.g., due to altered air gaps). It is therefore important to make the mechanical structure of the electric motor sufficiently robust to ensure the necessary exact alignment of the electric or magnetic parts. When designing the rotor and the stator, it is therefore important that these components are not deformed to an unacceptable degree either by forces generated by the motor itself or by external loads acting on the motor, or by inertial forces, such as the centrifugal force acting on the rotor. In addition, the bearing of the rotor must be sufficiently stiff to ensure the exact alignment of the rotor and stator.

In the practical design of electric motors for motor vehicles, the need to make the structure of the electric motor particularly stiff often conflicts with the requirements for compact design, low weight, high power density and low costs that always exist in vehicle construction.

### SUMMARY

The object of the present disclosure is to provide an electric machine arrangement with an electric machine that enables a structure that is as compact and light as possible as well as sufficiently robust.

This object is achieved by an electric machine arrangement, comprising an electric machine for driving an electrically drivable motor vehicle with one or more of the features described herein.

An electric machine arrangement constructed according to the disclosure comprises an electric machine having a stator and having a rotor, and further comprises an output element that is in rotationally fixed contact with the rotor. According to the invention, an axially elastic length-compensation element for transmitting torque is arranged between the rotor of the electric machine and the output element. This allows the desired axial length compensation to be achieved in a targeted manner and with a correspondingly positive (compensating) effect. If the axially elastic compensation element is arranged between the rotor and the output element, axial displacements between the output element and the stator of the electric machine can be compensated for in the axially elastic element without the axial displacements of the output element being transmitted to the rotor. If this were not the case, the displacements of the output element would lead to an axial displacement of the rotor relative to the stator or to a deformation of the rotor and/or the stator. This prevents unwanted displacements or deformations from occurring in the electric machine, which would have a negative impact on the properties of the electric machine.

Instead of designing all load-bearing components to be particularly stiff, robust and large, it usually makes more sense to take additional measures or provide additional components at suitable points to ensure that the load on the neighboring parts is reduced. A torque-transmitting length-compensation element is therefore proposed for the connection between an electric machine (e.g. an axial flux motor) and a unit of the drive train (e.g. a transmission or the like) connected to the electric machine. The axially soft but torque-transmitting connection prevents axial forces and/or axial displacements, which are caused by a transmission or another unit of the drive train, from being transmitted directly to the structure of the electric machine. This connection reduces the forces acting on the electric machine from the outside and thus also enables a more delicate, space-saving and less expensive construction of an electric machine, in which the required positioning accuracies are nevertheless guaranteed. According to the disclosure, the axially elastic length-compensation element can be formed by a component that is axially elastic due to its elastic material or by a component that is arranged to be movable or guided in the axial direction (also itself designed as a non-elastic part). In this case, the component arranged to be movable in the axial direction can also be subjected to spring force in the axial direction via a spring element or itself be formed from a material, as a result of which an axially elastic or axially movable effect can be achieved.

Further advantageous embodiments are specified below and in the claims. The features listed individually in the claims can be combined with one another in a technologically meaningful manner and can define further embodiments according to the disclosure. In addition, the features indicated in the claims are specified and explained in more detail in the description, wherein further preferred embodiments are shown.

First, the individual elements of the subject matter disclosed herein are explained in the order in which they are named in the set of claims or according to their relevance with respect to the disclosure, and particularly preferred embodiments of the subject matter according to the disclosure are described below.

Electric machines are used to convert electrical energy into mechanical energy and/or vice versa, and generally include a stationary part referred to as a stator, stand, or armature, and a part referred to as a rotor or runner, and arranged to be movable relative to the stationary part.

In the case of electric machines designed as rotation machines, a distinction is made in particular between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator.

The housing encloses the electric machine. A housing can also receive the control and power electronics. The housing can furthermore be part of a cooling system for the electric machine and can be designed in such a way that cooling fluid can be supplied to the electric machine via the housing and/or the heat can be dissipated to the outside via the housing surfaces. In addition, the housing protects the electric machine and any electronics that may be present from external influences.

The stator of a radial flux machine is usually constructed cylindrically and generally consists of electrical laminations that are electrically insulated from one another and are constructed in layers and packaged to form laminated cores. With this structure, the eddy currents in the stator caused by the stator field are kept low. Distributed over the circumference, grooves or peripherally closed recesses are let into the electrical lamination running parallel to the rotor shaft and receive the stator winding or parts of the stator winding. On the basis of the construction towards the surface, the slots can be closed with locking elements such as locking wedges or covers or the like to prevent the stator winding from being detached.

A rotor is the rotating (spinning) part of an electric machine. In particular, a rotor is used when there is also a stator. The rotor generally comprises a rotor shaft and one or more rotor bodies arranged on the rotor shaft in a rotationally fixed manner. The rotor shaft can also be hollow, which on the one hand saves weight and on the other hand allows lubricant or coolant to be supplied to the rotor body.

The gap between the rotor and the stator is called the air gap. In a radial flux machine, this is an axially extending annular gap with a radial width that corresponds to the distance between the rotor body and the stator body. The magnetic flux in an electric axial flux machine, such as an electric drive machine of a motor vehicle designed as an axial flux machine, is directed axially in the air gap between the stator and rotor, parallel to the axis of rotation of the electric machine. The air gap that is formed in an axial flux machine is thus essentially in the form of an annular disk.

The magnetic flux in an electric axial flux machine, such as an electric drive machine of a motor vehicle designed as an axial flux machine, is directed axially in the air gap between the stator and rotor, parallel to the axis of rotation of the electric machine. With axial flux machines, a differentiation is made, among other things with a view to their expansion, between axial flux machines in an I arrangement and axial flux machines in an H arrangement. An axial flux machine in an I arrangement is understood as meaning an electric machine in which a single rotor disk of the electric machine is arranged between two stator halves of a stator of the electric machine and can be subjected to a rotating electromagnetic field. An axial flux machine in an H arrangement is understood as meaning an electric machine in which two rotor disks of a rotor of the electric machine receive a stator of the electric machine in the annular space located axially between them, via which the two rotor disks can be subjected to a rotating electromagnetic field.

According to an advantageous embodiment, it can be provided that the axially elastic length-compensation element is designed in such a way that backlash-free power transmission is ensured in the direction of rotation for torque transmission. This always ensures immediate, instantaneous power transmission to the output element coupled to the rotor.

Furthermore, according to a likewise advantageous embodiment, it can be provided that the axially elastic compensation element is formed by at least one leaf spring or a leaf spring assembly—in particular a plurality of leaf springs or leaf spring assemblies distributed circumferentially—or is formed by a corrugated pipe or is formed by an annular disk. The advantageous effect of these designs of a length-compensation element is based on the fact that highly efficient means for axial length compensation between the electric machine and an output element or between the stator of an electric machine and a supporting component, such as a housing or the like, can be implemented with structurally simple means.

According to a further particularly preferred embodiment, it can be provided that in the event that the axially elastic length-compensation element is formed by at least one circumferentially arranged leaf spring or a plurality of circumferentially distributed leaf springs or at least one leaf spring assembly or a plurality or circumferentially distributed leaf spring assemblies, and these are arranged and fastened in such a way that, viewed in the circumferential direction in which the electric machine transmits the greater torque to the output element in operation, the fastening point of a leaf spring or of a leaf spring assembly on the side facing the rotor, viewed circumferentially, is located in front of the fastening point of the same leaf spring or of the same leaf spring assembly on the side facing the output element, so that the greater torque can be transmitted to the output element in the form of a tangential tensile force via the axially elastic length-compensation element. By arranging the leaf springs in such a way that, viewed in the circumferential direction in which the motor transmits the greater torque to the downstream components during operation, the fastening point of the leaf springs to the rotor are arranged before the fastening points of the same leaf springs to the shaft, the greatest torque of the motor in the form of a tangential tractive force can be transmitted very efficiently via the leaf springs to the shaft or a component connected to the shaft. In the other circumferential direction, in which the motor delivers the lower torque, the leaf springs then transmit this torque through compressive forces. Due to the elongated, slender shape of the leaf springs, the maximum compressive forces that can be transmitted in the longitudinal direction in the leaf springs are limited by the buckling of the leaf springs. This problem of the leaf springs does not occur under tensile loading and is prevented by the proposed arrangement of the leaf springs.

Furthermore, the disclosure can also be further developed in such a way that the electric machine arrangement has a housing for receiving the electric machine, wherein the housing forms the component supporting the stator and the stator is arranged at least in a rotationally fixed manner within the housing and wherein the rotor is rotatably mounted on the housing. This has the advantage that the supporting forces of the rotor are introduced directly into the housing and do not have to be transmitted via the stator. The mechanical structure of the stator is thus less heavily loaded and the load-bearing elements of the stator can be made lighter, less expensive and more space-saving.

In a likewise preferred embodiment variant, it can also be provided that the electric machine arrangement has a housing for receiving the electric machine, wherein the stator is arranged in a rotationally fixed manner within the housing and wherein the rotor is rotatably mounted on the stator. A further optimization of the installation space can be achieved in this way. If the rotor is mounted directly on the stator, there is a very short tolerance chain between the components of the stator and the rotor. As a result, a precise alignment of all magnetically significant components of the electric machine can be achieved during assembly without complex subsequent adjustment processes. In addition, the electric motor is not adversely affected by changes in the housing, such as those that can occur during vehicle operation, for example due to thermal expansion or elastic deformation.

It can also be advantageous to further develop the disclosure such that the rotor is connected to the or an output element via a first axially elastic length-compensation element and a second axially elastic length-compensation element connected in series with the first axially elastic length-compensation element relative to the torque flow. The advantage that can be achieved in this way is that the forces to be balanced within the electric machine arrangement can be distributed to different locations within the machine. This results in improved compensation behavior and also presents an advantage with regard to a space-optimized design. The axially elastic length-compensation elements connected in series with regard to their axially elastic or axially movable properties can be arranged directly one behind the other or spatially spaced apart; for example, connected to the two axially spaced rotor halves on different sides of an axial flux machine constructed in an I arrangement. Due to the fact that the two axially elastic length-compensation elements are arranged in two axially spaced planes and are coupled to one another by a torque-transmitting connecting element that can tilt about an axis orthogonal to the axis of rotation, not only an axial offset or an axial movement between the rotor and the output element can be compensated by this structure, but also a radial offset or a radial movement. The axially elastic elements allow an angular offset between the axis of rotation of the rotor and the axis of rotation of the connecting element, and between the axis of rotation of the connecting element and the axis of rotation of the output element.

According to a further preferred development according to the disclosure, it can also be provided that a further axially elastic length-compensation element is provided, which is then arranged between the stator and the component supporting the stator, in particular between the stator and a housing of the electric machine, which allows additional length compensation in the drive train of an electrically drivable motor vehicle. This achieves a further option for compensating for axial movements that are unintentional and due to tolerances and/or temperature-related material volume changes, but also radial movements. Thus, the length-compensation element can be designed as an extension that extends in the axial direction or in the radial direction, which is arranged so as to be guided in regions in a corresponding recess, wherein the extension is connected either to the stator or to the component supporting the stator, and wherein the corresponding recess is formed in the supporting component or in the stator. Advantageously, the extension is designed as a pin and is mounted in the region of its guide, in the corresponding receptacle for the axial compensation, so that it can be moved by force via an elastomer or other spring means.

According to a further preferred embodiment of the subject matter disclosed herein, it can be provided that the electric machine is designed as an axial flux machine. Due to their usually disk-shaped design (axial length of the motor less than the motor diameter) and due to the air gaps between the rotor and the stator being aligned orthogonally to the axial direction, axial flux machines are particularly sensitive to axial forces acting on them from outside or axial displacements which seek to displace the rotor relative to the stator. The disk-shaped design always tends to lead to rotor structures that are rather axially soft, and the air gaps aligned orthogonally to the axial direction mean that even small axial shape deviations have a strong negative effect on the efficiency of the electric machine. The proposed axially elastic length-compensation elements, which can protect an electric machine from axial forces or displacements acting on it from the outside, are therefore particularly useful for axial flux machines.

Finally, the disclosure can also be advantageously implemented in such a way that the electric machine arrangement has a first electric machine designed as an axial flux machine and a second electric machine designed as an axial flux machine arranged in a common housing, wherein the rotor of the first electric machine drives a first output element on one axial side of the machine arrangement via a first axially elastic element and wherein the rotor of the second electric machine drives a second output element on the opposite axial side of the machine arrangement via a second axially elastic element. This preferred design makes it possible to provide an arrangement of a twin motor that is optimized in terms of installation space and weight; for example, for independent simultaneous driving of two wheels of a vehicle axle.

Advantageously, the output element can be designed as a shaft and can be mounted rotatably in the supporting component designed as a housing, as a result of which an optimized design with regard to the distribution of the forces to be balanced is made possible. If the electric machine and the output element, for example designed as a shaft, are supported on the same component, it is particularly simple to ensure that the electric machine and the output element are precisely aligned. In addition, a functional integration in which a supporting component, for example a housing, supports and connects several components to one another is a particularly compact, robust and economical solution.

Overall, the disclosure and its indicated further developments show an electric machine arrangement that enables an improved connection to downstream components of the drive train of an electrically drivable motor vehicle. In particular, the type of connection reduces the forces acting on the electric machine from the outside. This enables an intricate, space-saving and economical construction of the machine arrangement, which ensures the required positioning accuracy within the arrangement.

### BRIEF DESCRIPTION OF THE DRAWINGS

Both the disclosure and the technical field are explained in more detail below with reference to the figures. It should be noted that the disclosure is not intended to be limited by the exemplary embodiments shown. In particular, unless explicitly stated otherwise, it is also possible to extract partial aspects of the substantive matter outlined in the figures and to combine them with other components and knowledge from the present description and/or figures. In particular, it should be noted that the figures and in particular the proportions shown are only schematic in nature. Identical reference symbols indicate the same objects, so explanations from other figures can also be used. Although the disclosure is primarily illustrated using the example of axial flux machines, the solutions presented can also be transferred to radial flux machines.

In the figures:

FIG. 1 shows an electric machine arrangement according to the disclosure in a first possible embodiment in an axial section in a schematic representation,

FIG. 2 shows an electric machine arrangement according to the disclosure in a second possible embodiment in an axial section in a schematic representation,

FIG. 3 shows an electric machine arrangement according to the disclosure in a third possible embodiment in an axial section in a schematic representation,

FIG. 4 shows an electric machine arrangement according to the disclosure in a fourth possible embodiment in an axial section in a schematic representation,

FIG. 5 shows an electric machine arrangement according to the disclosure in a fifth possible embodiment in an axial section in a schematic representation,

FIG. 6 shows an electric machine arrangement according to the disclosure in a sixth possible embodiment in an axial section in a schematic representation,

FIG. 7 shows a detail of an electric machine arrangement according to the disclosure in a further possible embodiment in an axial section in a schematic representation,

FIG. 8 shows an electric machine arrangement according to the disclosure with an electric machine designed as a radial flux machine in a possible embodiment in an axial section in a schematic representation, and

FIG. 9 shows an electric machine arrangement according to the disclosure in a further embodiment with an electric machine designed as a radial flux machine in an axial section in a schematic representation.

### DETAILED DESCRIPTION

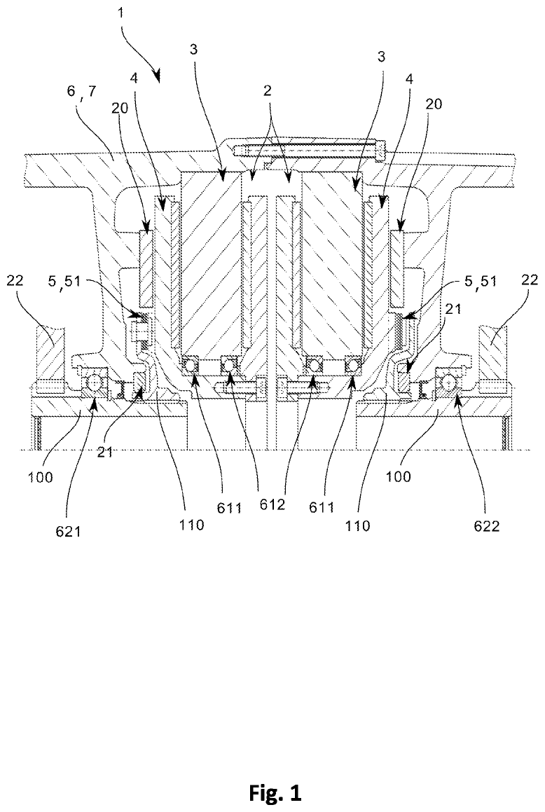

All drawing figures—FIGS. 1-7—show different embodiments according to the disclosure using the example of differently designed axial flux machines; although the disclosure is not limited to axial flux machines, but rather can also be used in radial flux machines.

FIGS. 1-4 show exemplary embodiments of an electric machine arrangement 1 with an electric machine 2, wherein the rotor 4 of an electric machine 2 is constructed in an I arrangement or in an H arrangement and designed as an axial flux machine mounted directly on the stator 3.

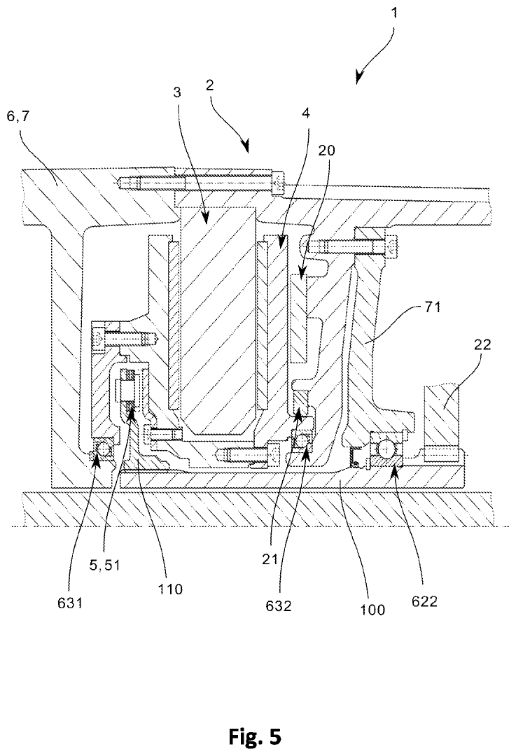

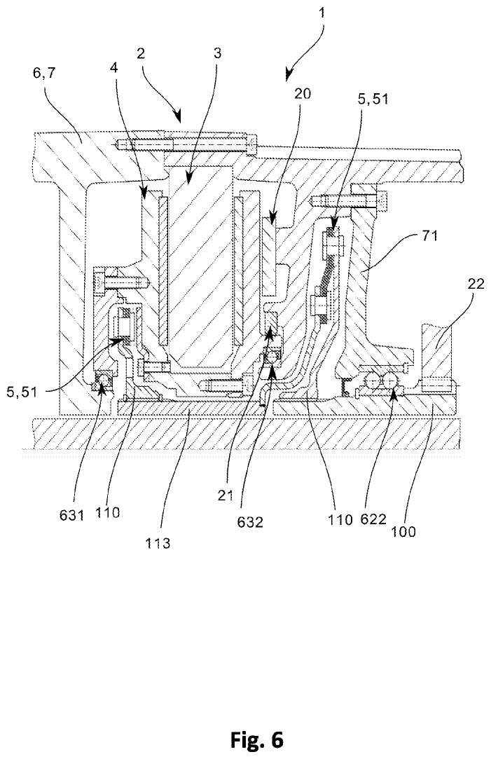

Machine arrangements 1 with electric machines 2 designed as axial flux machines are shown in FIGS. 5-6, in which the rotor 4 is mounted in side walls of the housing 7 in each case.

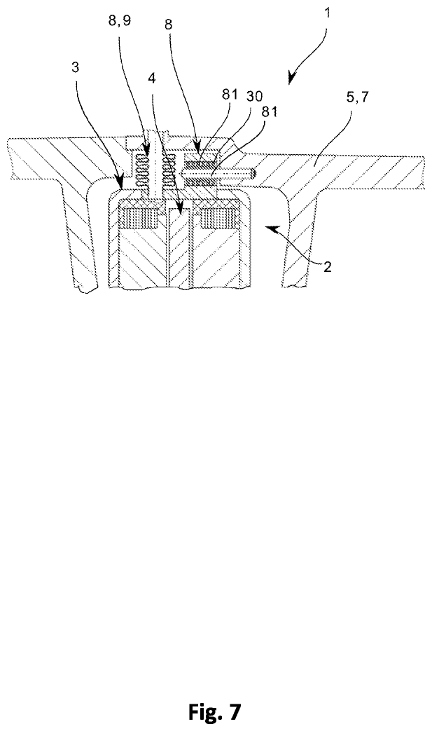

A detail of the machine arrangement 1 in FIG. 7 shows a torque support 8 of the stator 3 on the housing 7, through which a further length compensation is achieved.

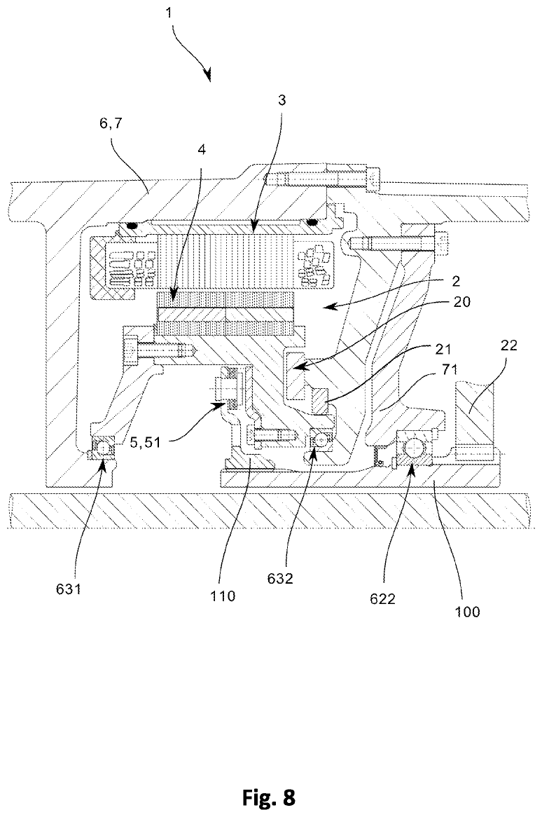

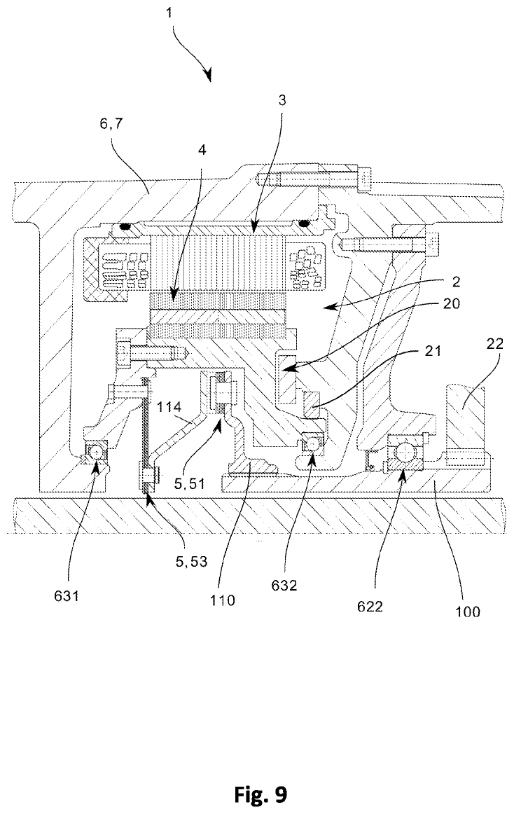

In FIGS. 8 and 9, two approaches adapted to the radial flux machine are shown as representative of the other approaches that were explained exclusively using the example of the axial flux machine.

FIG. 1 shows an electric machine arrangement 1 in a first possible embodiment in an axial section in a schematic representation. The electric machine arrangement 1 shown comprises two electric machines 2 arranged next to one another in a common housing 7 and designed as axial flux motors in an H arrangement. The stators 3 of the electric machines 2 are fastened to the housing 7 radially on the outside in a rotationally fixed and preferably non-displaceable manner and carry a bearing point 611, 612 radially on the inside (consisting of two angular ball bearings in an O arrangement) via which the respective rotor 4 is mounted on the respective stator 3. Radially on the inside, each rotor 4 comprises a section similar to a hollow shaft, which is connected to the respective stator 3 via the bearing point 611, 612 and to which disk-shaped sections of the rotor 4 adjoin on the right and left, which extend radially outwards next to the stator 3. The air gaps through which the axial magnetic flux of the motor runs are located between a stator 3 and the two disk-shaped sections of a rotor 4. In this exemplary embodiment, a measuring surface is provided on the disk-shaped rotor section facing away from the other electric machine 2 in each case, which can be detected and evaluated by the rotor position sensor 20 fastened to the housing 7. The rotors 4, which are driven by the magnetic spring of the electric machine 2, each transmit their torque to a coupling element 110 via an axially elastic length-compensation element 5 formed from leaf spring assemblies 51 distributed around the circumference. Both coupling elements 110 are each connected via a spline to an output element 100 designed as an output shaft. The output shafts are each mounted via a further bearing point 621, 622 in the side walls of the housing 7 of the electric machine.

In addition, in this exemplary embodiment, a grounding ring 21 is provided between the coupling element 110 and the housing 7, via which the currents induced in the rotor 4 can be discharged into the housing 7. Each output shaft is mounted in a side wall of the housing 7, through which it protrudes from the space in which the motors are located into the space in which their associated transmission is located. In order to separate these two spaces from one another in an oil-tight manner, the shaft is sealed in the housing wall with a radial shaft seal. The transmission is indicated in the figure by a toothing stage 22 in each case. The housing 7 is designed to be divided axially in the middle, as a result of which simplified assembly of the electric machine arrangement 1 is achieved.

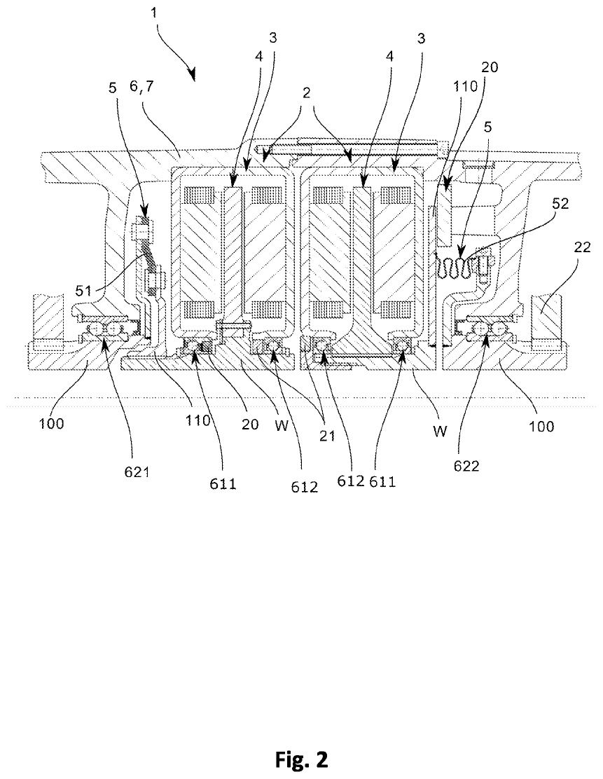

FIG. 2 shows an electric machine arrangement 1 according to the disclosure in a second possible embodiment in an axial section in a schematic representation. FIG. 2 shows that the axially soft torque-transmitting connection concept presented in FIG. 1 with electric machines 2 designed as axial flux motors in an H arrangement can also be transferred to electric machines 2 in an I arrangement. In the case of axial flux motors in an I arrangement, two stators 3 each, each with two stator halves arranged in a stator housing and each receiving a rotor 4 in their center, are fastened radially on the outside to the housing 7 and each carry a bearing point 611, 612 radially on the inside, on which the rotor shaft W is mounted relative to the stator 3 or the stator housing. Each bearing point 611, 612, which is located radially on the inside of one of the stator halves of a stator 3, consists in this exemplary embodiment of an angular ball bearing that forms an O arrangement together with the second angular ball bearing on the second stator half 3. The rotor 4 is fastened to the rotor shaft W in each case and consists of a disk-shaped section which extends radially outwards between the two stator halves of a stator 3. The air gaps through which the axial magnetic flux of the electric machine 2 runs are located between the two stator halves of a stator 3 and the rotor 4. The rotors 4 of the electric machines 2 shown in FIG. 2 transmit the torque caused by the magnetic springs of the motors to the rotor shafts (rotor shaft sections) W. In the electric machine 2 shown on the left, the rotor shaft W is connected via leaf springs 51 to the output element 100 or to the downstream unit of the drive train, such as a transmission. In this exemplary embodiment, the rotor shaft W is connected via a spline to a coupling element 110, to which a plurality of circumferentially distributed leaf spring assemblies 51 are fastened. Each leaf spring assembly 51 extending approximately tangentially (in the circumferential direction) is fastened (e.g. riveted) with its other end region of the tangential extent to a connecting flange fastened (e.g. welded) to the output shaft. The leaf spring assembly shown in FIG. 2 is shown turned by about 90° in the figure for a better overview, in order to be able to show the two connection points of the leaf spring assembly 51 in the sectional plane of FIG. 2. In a real structure, however, a tangential alignment of the leaf springs makes more sense. In the left electric machine 2, the spline between the rotor shaft W of the electric machine 2 and the coupling element 110 represents a simple assembly interface for the electric machine 2. The common housing 7 of the two electric machines 2 can be divided in the middle so that the motor can be inserted laterally into the housing half after the transmission has already been installed in its housing region behind the side wall and tested. When the motor is inserted into the housing half, the two spline contours of the coupling element 110 and the rotor shaft W are pushed into one another and a form-fitting connection is thus created.

A rotor position sensor 20 is placed at one bearing of the rotor shaft W on the left motor and a grounding ring 21 at the other bearing.

In the motor on the right in FIG. 2, the rotor shaft W is welded to a connecting disk (coupling element 110), which forms the measuring surface for the rotor position sensor 20. The connecting disk is also used to transmit torque between the motor and the output element 100 (transmission). For this purpose, a corrugated pipe 52 (e.g. metal bellows) is arranged between the connecting disk and a connecting element 111 connected (e.g. welded) to the drive shaft (output element 100). This corrugated pipe 52 is arranged concentrically to the rotor axis of the electric machine 2 and is welded to the connecting disk on one side and to a connecting ring 112 on the other side. In order to create a backlash-free assembly interface, the connecting ring 112 is screwed to the connecting element 111 by means of a plurality of radially arranged screws. Even after the electric machine 2 has been installed in the housing 7, the screws are accessible through radial openings in the housing 7 that can be closed with covers. The corrugated pipe 52 is designed to be elastic in the axial direction and sufficiently torsionally rigid in the circumferential direction. Like the leaf springs 51 described above and the flexplate 53 described below, the corrugated pipe 52 is a possible embodiment for an axially soft but torque-transmitting connection.

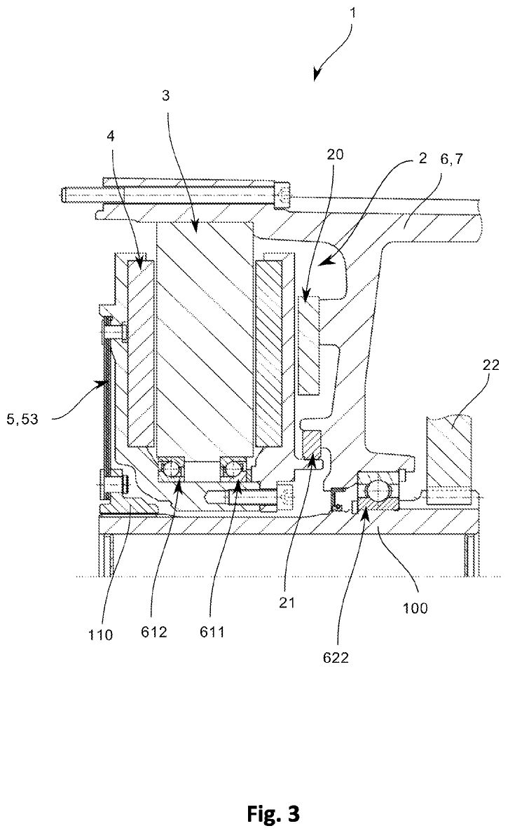

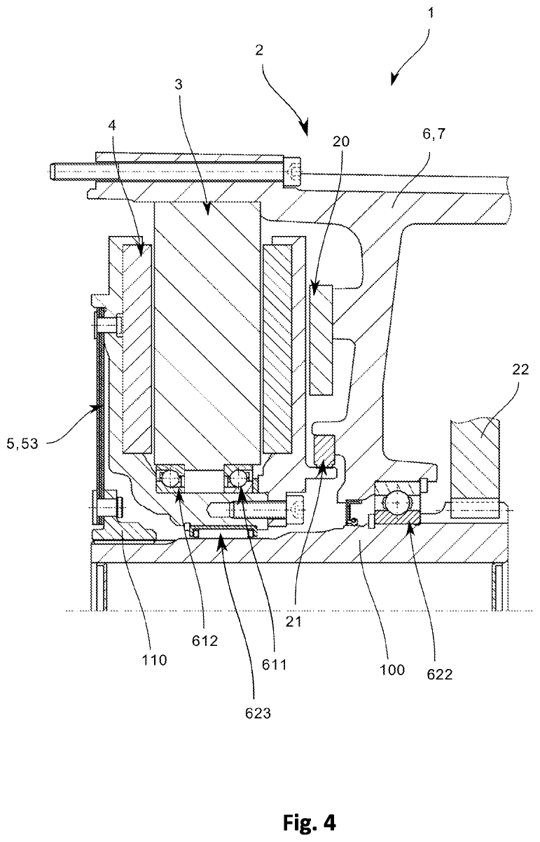

FIGS. 3 and 4 each show an electric machine arrangement 1 according to the disclosure in a third or fourth possible embodiment in an axial section in a schematic representation. FIGS. 3 and 4 show two exemplary embodiments in which the axially soft but torque-transmitting connecting element—also referred to as an axially elastic length-compensation element 5 within the scope of the disclosure—is arranged on the side of the electric machine 2 facing away from the transmission or the output element 100. On the rear side of the rotor half facing away from the transmission, an axially elastic length-compensation element 5 designed as a flexplate or as an annular disk 53 is fastened radially on the outside. For this purpose, centering and riveting points are distributed over the circumference of the rotor 4. The flexplate is connected (riveted) to a hub (coupling element 110) radially on the inside, which is connected to the output element 100 (transmission input shaft) designed as a drive shaft via a form-fitting connection (spline). The flexplate is a thin disk arranged concentrically to the axis of rotation of the electric machine 2 (e.g. a thin sheet metal disk made of spring steel or an assembly of a plurality of thin sheet metal disks lying one on top of the other), which is fastened radially on the outside at several points distributed around the circumference on one component and radially on the inside at several points distributed around the circumference on another component. The flexplate can transmit torque from radially outward to radially inward and vice versa, and at the same time, because of its thin planar shape, the flexplate is axially soft in the direction of the axis of rotation of the electric machine 2 (orthogonal to the sheet plane of the flexplate) and can thus compensate for axial displacements between the electric machine 2 and the output element 100. In FIGS. 3 and 4, the stator 3 of the electric machine 2 is fastened to the housing 7 and the rotor 4 is rotatably mounted on the stator 3.

FIG. 3 shows an exemplary embodiment in which the transmission input shaft is supported radially and axially on one side with a bearing 622 on the side housing wall of the housing 7 and can additionally radially support itself on the other side radially via the hub (or the coupling element 110) and the flexplate (annular disk 53) on the rotor 4 of the electric machine 2. Since the axial distance between the flexplate and the bearing 622 supporting the transmission input shaft on the housing wall is large, small axial offset errors between the transmission and the rotor 4 of the electric machine 2 can be compensated for by a slight misalignment of the output element 100 designed as a drive shaft. The exemplary embodiment of FIG. 4 is very similar to that of FIG. 3; however, a needle bearing 623 is additionally installed between the transmission input shaft (output element 100) and the rotor 4. This variant can hardly compensate for axial offset errors and is therefore dependent on a very precise alignment between the electric machine 2 and the transmission or the output element 100. However, significantly greater radial supporting forces can be introduced into the electric machine 2 from the output element (transmission shaft) through the needle bearing 623. Since the needle bearing 623 is located directly in the center of the electric machine 2, the supporting forces are also introduced centrally into the electric machine 2 and do not cause any tilting moment that acts on the rotor 4.

FIG. 5 shows an electric machine arrangement 1 according to the disclosure in a fifth possible embodiment in an axial section in a schematic representation. FIG. 5 shows that even in the case of electric machines 2 whose rotor 4 is not mounted directly on the stator 3, an axially soft torque-transmitting connection to the downstream components of the drive train is possible. FIG. 5 shows an axial flux motor in an H arrangement, the rotor 4 of which is mounted on the right and left on or in the side walls of the housing 7 via bearing points 631, 632. To ensure that the deformations caused by the transmission and/or other units of the drive train connected to the electric machine 2 (e.g. a vehicle wheel) do not have a negative effect on the electric machine 2, in this type of mounting of the rotor 4 not only the shaft but also the side wall of the housing 7 on which the rotor 4 is supported must be considered. In this exemplary embodiment, therefore, a separate support wall 71 was provided for the transmission, which is screwed to the side of the housing 7. Since the transmission now supports its axial forces on its own support wall 71 and does not transmit the axial forces to the same housing side wall on which the rotor 4 is mounted, no unwanted constraining forces and/or displacements are transmitted from the housing side wall to the rotor 4. In this exemplary embodiment, the transmission input shaft or the output element 100 is again connected to the rotor 4 via leaf springs 51 (as already shown in FIG. 1), so that displacements of the shaft do not have a negative effect on the rotor 4.

The separate support wall 71 for the transmission also provides the advantage that this wall can be made from a different material than the rest of the transmission or the housing 7. It is thus possible, for example, to produce the support wall 71 from steel in order to achieve the high modulus of elasticity to reduce the deformations and to make the other housing components from aluminum to save weight. FIG. 5 shows, by way of example, that in the exemplary embodiments presented here there is space radially on the inside in order to insert a separate shaft through the electric machine arrangement 1 described here. This is particularly useful for e-axles, where torque is to be transmitted from a transmission arranged on one side of the e-motor to both wheels of the vehicle. The torque transmission from the transmission to the wheel arranged on the other side of the electric motor can then take place via this separate shaft inserted through the electric motor radially on the inside.

FIG. 6 shows an electric machine arrangement 1 according to the disclosure in a sixth possible embodiment in an axial section in a schematic representation. FIG. 6 shows an exemplary embodiment in which the electric machine 2 is not only protected against axial displacements of the neighboring components, but also axial offset and angular errors between the electric machine 2 and a unit of the drive train receiving the torque of the electric machine 2 can be compensated. The difference between the embodiment shown in FIG. 5 and the embodiment shown in FIG. 6 is that the transmission input shaft (output element 100), which is mounted in the separate support wall 71 via a bearing point 622 of the housing 7, is not designed as one piece up to an axially elastic connection point on the rotor 4. According to FIG. 6, the rotor 4 is connected to a connecting sleeve 113 via a first axially soft torque-transmitting connection point (or via a first axially elastic length-compensation element 5). This connecting sleeve 113 is then connected to the transmission input shaft (output element 100) via a second axially soft torque-transmitting connection point (or via a second axially elastic length-compensation element 5). Since the axially elastic length-compensation elements 5, 51 (the leaf spring assemblies 51 already described in FIG. 1 and FIG. 2 are shown in FIG. 6) can not only compensate for axial deformations, but also for an angular offset between the two axes of rotation of the adjacent assemblies, the connecting sleeve 113 between the two axially elastic length-compensation elements 5 can slightly incline relative to the axis of rotation of the rotor 4 and/or to the axis of rotation of the transmission input shaft (of the output element 100). Due to the inclined position of the connecting sleeve 113 relative to one or both neighboring systems, the connecting sleeve 113 can compensate for angular errors, axial offsets and wobbling movements of the neighboring systems. The transmission with its transmission input shaft is only to be understood here as an example of a unit of the drive train that absorbs the torque of the electric machine 2. The functional principle described here also works when the electric machine 2 is connected to another unit or to another element.

FIG. 7 shows a detail of an electric machine arrangement 1 according to the disclosure in a further possible embodiment in an axial section in a schematic representation. According to the embodiment shown, the stator 3 is supported in the direction of rotation with the interposition of a further length-compensation element—here in the form of a torque support 8—and is connected to the housing 7 so that it is at least axially movable relative thereto. The torque support 8 is designed as an extension 81 fixed in a wall of the housing 7 and extending in the axial direction parallel to the axis of rotation of the electric machine 2, which is arranged so as to be guided in regions in a corresponding receptacle 30 in the body or in the housing of the stator 3. The extension 81 designed as a pin is mounted in the region of its guide, in the corresponding receptacle 30 for the axial compensation, so that it can be moved by force via an elastomer or other spring means. In addition, a supply line 9 is shown, which is fed to the stator housing from above through the housing wall; for example, in order to supply it with cooling liquid. The supply line 9 is designed to be elastic in regions, which is illustrated here by a section designed as a corrugated pipe. As a result, the supply line can also compensate for the undesired movements between the stator 3 and the housing 7 and help to avoid voltages occurring within the electric machine 2.

FIG. 8 shows an electric machine arrangement 1 according to the disclosure with an electric machine 2 designed as a radial flux machine in a possible embodiment in an axial section in a schematic representation. The embodiment shown here with a radial flux machine corresponds to the embodiment shown in FIG. 5 with an axial flux machine in terms of structure and functionality. FIG. 8 shows a radial flux motor, the rotor 4 of which is mounted on the right and left on or in the side walls of the housing 7 via bearing points 631, 632. To ensure that the deformations caused by the transmission and/or other units of the drive train connected to the electric machine 2 (e.g. a vehicle wheel) do not have a negative effect on the electric machine 2, in this type of mounting of the rotor 4 not only the shaft but also the side wall of the housing 7 on which the rotor 4 is supported must be considered. In this exemplary embodiment, therefore, a separate support wall 71 was provided for the transmission, which is screwed to the side of the housing 7. Since the transmission now supports its axial forces on its own support wall 71 and does not transmit the axial forces to the same housing side wall on which the rotor 4 is mounted, no unwanted constraining forces and/or displacements are transmitted from the housing side wall to the rotor 4. In this exemplary embodiment, the transmission input shaft or the output element 100 is also connected to the rotor 4 via leaf springs 51, so that displacements of the shaft do not have a negative effect on the rotor 4.

The separate support wall 71 for the transmission also provides the advantage that this wall can be made from a different material than the rest of the transmission or the housing 7. It is thus possible, for example, to produce the support wall 71 from steel in order to achieve the high modulus of elasticity to reduce the deformations and to make the other housing components from aluminum to save weight. FIG. 8 shows, by way of example, that in the exemplary embodiments presented here there is space radially on the inside in order to insert a separate shaft through the electric machine arrangement 1 described here. This is particularly useful for e-axles, where torque is to be transmitted from a transmission arranged on one side of the e-motor to both wheels of the vehicle. The torque transmission from the transmission to the wheel arranged on the other side of the electric motor can then take place via this separate shaft inserted through the electric motor radially on the inside.

FIG. 9 shows an electric machine arrangement 1 according to the disclosure in a further embodiment with an electric machine 2 designed as a radial flux machine in an axial section in a schematic representation. The embodiment shown here with a radial flux machine essentially corresponds to the embodiment shown in FIG. 6 with an axial flux machine in terms of structure and functionality. FIG. 9 shows an electric machine arrangement 1 according to the disclosure in a further possible embodiment with an electric machine 2 designed as a radial flux machine in an axial section in a schematic representation. FIG. 9 shows an exemplary embodiment in which the electric machine 2 is not only protected against axial displacements of the neighboring components, but also axial offset and angular errors between the electric machine 2 and a unit of the drive train receiving the torque of the electric machine 2 can be compensated. The difference between the embodiment shown in FIG. 8 is that in the embodiment according to FIG. 9, two axially elastic length-compensation elements 5 are used instead of just one axial length-compensation element 5. In the embodiment shown here, two axially elastic length-compensation elements 5 connected via a connector ring are arranged connected in series one behind the other between the rotor 4 and the output element 100. According to FIG. 9, the rotor 4 is connected to a connector ring 114 via a first axially soft torque-transmitting connection point (or via a first axially elastic length-compensation element 5 in the form of an annular disk 53 (flexplate)). This connector ring 114 is then connected to the transmission input shaft (output element 100) via a second axially soft torque-transmitting connection point (or via a second axially elastic length-compensation element 5—here in the form of a leaf spring assembly 51). Since the axially elastic length-compensation elements 5 can not only compensate for axial deformations, but also for an angular offset between the two axes of rotation of the adjacent assemblies, the connector ring 114 between the two axially elastic length-compensation elements 5 can slightly incline relative to the axis of rotation of the rotor 4 and/or to the axis of rotation of the transmission input shaft (of the output element 100). Due to the inclined position of the connector ring 114 relative to one or both neighboring systems, the connector ring 114 can compensate for angular errors, axial offsets and wobbling movements of the neighboring systems. The transmission with its transmission input shaft is only to be understood here as an example of a unit of the drive train that absorbs the torque of the electric machine 2. The functional principle described here also works when the electric machine 2 is connected to another unit or to another element.

The other solutions shown for axial flux machines can also be transferred to the radial flux machine, as is the case here using two exemplary solutions transferred to the radial flux machine.

The axially elastic length-compensation elements 5, 51, 52, 53 shown in the exemplary embodiments are always only shown as examples for elements with these properties. In all of the exemplary embodiments, differently designed elements can always be used, for example leaf springs 51, annular disks 53 (flexplates) or corrugated bellows or corrugated pipes 52. In addition, the design of the elastic torque-transmitting elements is not limited to the three embodiments.

The disclosure as a whole is therefore not limited to the embodiments shown in the figures. The above description is therefore not to be regarded as limiting, but rather as explanatory. The following claims are to be understood as meaning that a named feature is present in at least one embodiment of the disclosure. This does not exclude the presence of further features. If the patent claims and the above description define ‘first’ and ‘second’ features, this designation serves to distinguish between two features of the same type without defining an order of precedence.

### LIST OF REFERENCE SYMBOLS

1 Machine arrangement
2 Machine
3 Stator
4 Rotor
5 Length-compensation element
51 Leaf springs
52 Corrugated pipe
53 Annular disk
6 Component
7 Housing
70 Receptacle
71 Support wall
20 Rotor position sensor
21 Grounding ring
22 Transmission, toothing stage
100 Output element
110 Coupling element
111 Connecting element
112 Connecting ring
113 Connecting sleeve
114 Connector ring
W Rotor shaft
611, 612 Bearing point (rotor/stator)
621, 622 Bearing point (output shaft/housing)
623 Needle bearing (rotor/output shaft)
631, 632 Bearing point (rotor/housing)

1. An electric machine arrangement comprising:
an electric machine for driving an electrically drivable motor vehicle, the electric machine having a stator and having a rotor;
an output element (400) that is in rotationally fixed contact with the rotor; and
an axially elastic length-compensation element configured to transmit torque arranged between the rotor of the electric machine and the output element.

2. The electric machine arrangement according to claim 1, wherein the axially elastic length-compensation element is configured such that backlash-free power transmission is provided in a direction of rotation for torque transmission.

3. The electric machine arrangement according to claim 1, wherein the axially elastic compensation element comprises at least one leaf spring arranged circumferentially, at least one leaf spring assembly, a corrugated pipe, or an annular disk.

4. The electric machine arrangement according to claim 1, wherein the axially elastic length-compensation element comprises a circumferentially arranged leaf spring or leaf spring assembly arranged and fastened such that, viewed in a circumferential direction in which the electric machine transmits a greater torque to the output element in operation, a fastening point of the leaf spring or the leaf spring assembly on a side facing the rotor, viewed circumferentially, is located in front of a fastening point of said leaf spring or said leaf spring assembly on a side facing the output element, so that the greater torque is adapted to be transmitted to the output element as a tangential tensile force via the axially elastic length-compensation element.

5. The electric machine arrangement according to claim 1, further comprising a housing for receiving the electric machine, wherein the housing forms a component supporting the stator.

6. The electric machine arrangement according to claim 1, further comprising a housing for receiving the electric machine, wherein the stator is arranged in a rotationally fixed manner within the housing and the rotor is rotatably mounted on the stator.

7. The electric machine arrangement according to claim 1, wherein the axially elastic length-compensation element comprises first and second axially elastic length-compensation elements, the rotor is connected to the output element via the first axially elastic length-compensation element and the second axially elastic length-compensation element is connected in series with the first axially elastic length-compensation element in a torque flow.

8. The electric machine arrangement according to claim 1, wherein the stator is supported in a direction of rotation with a further length-compensation element and is connected to a component supporting the stator such that the further length-compensating element is at least axially movable relative thereto.

9. The electric machine arrangement according to claim 1, wherein the electric machine comprises comprises an axial flux machine.

10. The electric machine arrangement according to claim 1, wherein the electric machine comprises a first electric machine comprising an axial flux machine and a second electric machine comprising an axial flux machine arranged in a common housing, the axially elastic length-compensation element comprises first and second axially elastic length-compensation elements, and the output element comprises first and second output elements, and the rotor of the first electric machine drives the first output element on one axial side of the machine arrangement via the first axially elastic element and the rotor of the second electric machine drives the second output element on an opposite axial side of the machine arrangement via the second axially elastic element.

11. The electric machine arrangement according to claim 1, wherein the output element comprises a shaft and is rotatably mounted in a component supporting the stator.

12. An electric machine arrangement comprising:
an electric machine having a stator and having a rotor;
an output element in rotationally fixed contact with the rotor; and
an axially elastic length-compensation element configured to transmit torque arranged between the rotor and the output element.

13. The electric machine arrangement according to claim 12, wherein the axially elastic length-compensation element is configured such that backlash-free power transmission is provided in a direction of rotation for torque transmission.

14. The electric machine arrangement according to claim 12, wherein the axially elastic compensation element comprises at least one leaf spring arranged circumferentially, at least one leaf spring assembly, a corrugated pipe, or an annular disk.

15. The electric machine arrangement according to claim 12, wherein the axially elastic length-compensation element comprises a circumferentially arranged leaf spring or leaf spring assembly arranged and fastened such that, viewed in a circumferential direction in which the electric machine transmits a greater torque to the output element in operation, a fastening point of the leaf spring or the leaf spring assembly on a side facing the rotor, viewed circumferentially, is located in front of a fastening point of said leaf spring or said leaf spring assembly on a side facing the output element.

16. The electric machine arrangement according to claim 12, further comprising a housing for receiving the electric machine, wherein the housing forms a component supporting the stator.

17. The electric machine arrangement according to claim 12, further comprising a housing for receiving the electric machine, wherein the stator is arranged in a rotationally fixed manner within the housing and the rotor is rotatably mounted on the stator.

18. The electric machine arrangement according to claim 12, wherein the axially elastic length-compensation element comprises first and second axially elastic length-compensation elements, the rotor is connected to the output element via the first axially elastic length-compensation element and the second axially elastic length-compensation element is connected in series with the first axially elastic length-compensation element in a torque flow.

19. The electric machine arrangement according to claim 12, wherein the stator is supported in a direction of rotation with a further length-compensation element and is connected to a component supporting the stator such that the further length-compensating element is at least axially movable relative thereto.
